(19) United States
(12) Patent Application Publication
(10) Pub. No.: US 2017/0314498 A1
(43) Pub. Date: Nov. 2, 2017

(54) SYSTEM AND METHOD FOR FUEL INJECTION CONTROL

(71) Applicant: General Electric Company, Schenectady, NY (US)

(72) Inventor: HABEEB KHAN PATHAN, BANGALORE (IN)

(21) Appl. No.: 15/141,396

(22) Filed: Apr. 28, 2016

(51) Int. Cl. F02D 41/40; F02D 41/02; F02D 41/00; F02D 41/30; F02D 35/02

(52) U.S. Cl. CPC F02D 41/40; F02D 41/3035; F02D 35/023; F02D 41/009; F02D 41/0235

(57) ABSTRACT

A method for controlling an engine includes, with a fuel injector, injecting a quantity of fuel into a cylinder of the engine for combustion. The method further includes calculating a torsional power level for the cylinder in response to the combustion of the injected quantity of fuel, mapping the torsional power level to an injected fuel mass, and comparing the injected fuel mass to a reference fuel mass to determine a fuel mass offset. The engine may be controlled based on the determined fuel mass offset.

### BACKGROUND

### Technical Field

Embodiments of the invention relate generally to internal combustion engines. Certain embodiments relate to systems and methods for fuel injector offset calculation and fuel injection control.

### Discussion of Art

Environmental laws and regulations governing permissible emissions of internal combustion engines for vehicles and machinery make it necessary to take measures to control such emissions within acceptable levels. One such way of improving emissions is to achieve improved mixture preparation in the cylinders of the internal combustion engine. This can be achieved, for example, by utilizing fuel injectors to meter fuel into the cylinders at a defined pressure.

In operating an internal combustion engine, torque requirements of the engine are converted into injection quantities of fuel. Each injection quantity is correlated with an injection time as a function of an injection pressure. The resulting injection characteristic curves are stored as a nominal injection characteristic diagram in software of a controller for the engine, and are utilized to control the injection of a set quantity of fuel into the cylinders of the engine via a plurality of fuel injectors.

Operating modern combustion engines typically requires a highly accurate metering of the fuel mass at very high injection pressures. The precision of the controlled fuel metering is limited, however, by manufacturing accuracy and by characteristics of the components of the injection system that change during the lifetime such as for example, drifting appearances, which can cause increased tolerances. For example, the open pressure of the fuel injector, nozzle flow, injector spray hole cone angle, injector blow back resistance, spray tip temperature, needle lift, hydro erosion, nozzle damping clearance and nozzle dampening height may all influence the actual injected fuel quantity. These inaccuracies can cause significantly increased emissions and/or conspicuous and objectionable combustion noises depending on the operating point of the engine.

In view of the above, there may be a need for a system and method that differ from existing systems and methods.

### BRIEF DESCRIPTION

In an embodiment, a method for controlling an engine includes, with a fuel injector, injecting a quantity of fuel into a cylinder of the engine for combustion. The method further includes calculating a torsional power level for the cylinder in response to the combustion of the injected quantity of fuel, mapping the torsional power level to an actual injected fuel mass, and comparing the actual injected fuel mass to a reference fuel mass to determine a fuel mass offset value.

In another embodiment, an engine system includes a cylinder defining a combustion chamber of an engine, a piston received in the cylinder and configured for reciprocating movement within the cylinder, a fuel injector in communication with the combustion chamber and being configured to inject a quantity of fuel into the cylinder, and an engine control unit in communication with the fuel injector. The engine control unit being configured to control the quantity of fuel injected into the cylinder. The engine control unit is further configured to calculate a torsional power level for the cylinder in response to combustion of the quantity of fuel injected into the cylinder, to determine an actual injected fuel mass corresponding to the torsional power level, and to determine a fuel mass offset by comparing the actual injected fuel mass to a reference fuel mass.

In yet another embodiment, a method for controlling an engine includes, with a fuel injector, injecting a quantity of fuel into a cylinder of the engine for combustion. The method further includes calculating a torsional power level for the cylinder in response to the combustion of the injected quantity of fuel, and mapping the torsional power level to a mass (e.g., estimated mass) of the injected quantity of fuel (or otherwise determining an injected fuel mass corresponding to the torsional power level). The method further includes comparing the estimated mass to a reference fuel mass to determine a fuel mass offset value.

### DRAWINGS

The present invention will be better understood from reading the following description of non-limiting embodiments, with reference to the attached drawings, wherein below:

FIG. 1 is a schematic illustration of a system for engine (e.g., fuel injection) control, according to an embodiment of the invention.

FIG. 2 is a flow diagram of a method for engine control, based on calculating fuel mass offset values of fuel injectors of the engine.

FIG. 3 is a schematic illustration of a process of over- or under-fuel detection of the method of FIG. 2.

FIG. 4 is a diagram illustrating a half-order/first order power level comparison of a healthy fuel injector and a fuel injector exhibiting over-fueling.

FIG. 5 is a diagram illustrating exemplary injector excitation current adjustments in response to a fuel mass offset determination.

### DETAILED DESCRIPTION

Reference will be made below in detail to exemplary embodiments of the invention, examples of which are illustrated in the accompanying drawings. Wherever possible, the same reference characters used throughout the drawings refer to the same or like parts.

Embodiments of the invention relate generally to internal combustion engines. Certain embodiments relate to systems and methods for calculating fuel mass offset values of fuel injectors of an internal combustion engine and for controlling the injection of fuel in an internal combustion engine. In one embodiment, the method includes analyzing the frequency content of a crankshaft speed signal to identify torsional power levels of each cylinder of the engine during over-fueling at lower engine speeds. In an embodiment, the crankshaft speed can be determined using a crankshaft speed sensor associated with the crankshaft of the engine. Individual cylinders are over-fueled and the crankshaft acceleration from each tiring cylinder is leveraged to determine the torsional power and, in turn, the fuel quantity of each injector via the half order (or harmonics) associated with the spectral analysis (e.g., by Goertzel algorithm) of the speed signal. The engine control system can then leverage this data to tune performance as necessary to calculate each over-fuel quantity level of each cylinder and account for the difference between the base reference and the injected fuel quantity.

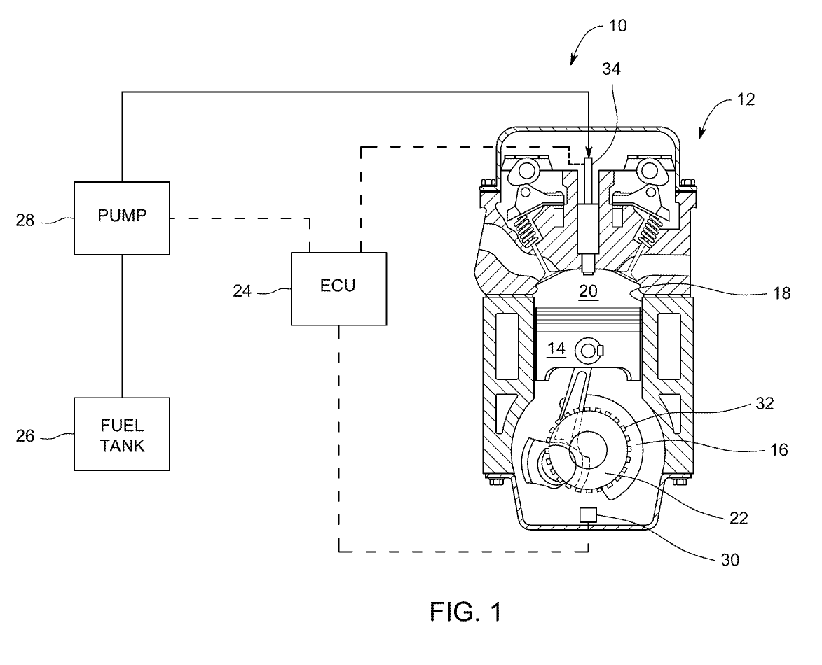

An embodiment of the invention provides for a system and method for the determination of the quantity of fuel injected in an internal combustion engine, in particular a diesel engine, whereby the engine comprises one or more cylinders, each cylinder having a respective injector. As illustrated in FIG. 1, the system 10 includes an internal combustion engine 12 (which is only partially depicted therein). The exemplary engine 12 comprises a multi-cylinder, direct-injection, compression-ignition internal combustion engine having reciprocating pistons 14 attached to a crankshaft 16 and movable in cylinders 18 which define variable volume combustion chambers 20. The crankshaft 16 is operably attached to a vehicle transmission and driveline to deliver tractive torque thereto, in response to an operator torque request (e.g., depression of a pedal or other operator adjustment of a throttle setting). The engine may employ a four-stroke operation wherein each engine combustion cycle comprises 720 degrees of angular rotation of the crankshaft 16 divided into four 180-degree stages of intake-compression-expansion-exhaust, which are descriptive of reciprocating movement of the piston 14 in the engine cylinder 18. A multi-tooth target wheel 22 is attached to the crankshaft 16 and rotates therewith. The engine includes sensing devices to monitor engine operation, and actuators which control engine operation. The sensing devices and actuators are signally or otherwise operatively connected to a control module or engine control unit 24.

In an embodiment, the engine 12 is a compression ignition engine, although the present invention is equally applicable to spark-ignition engines as well. During normal operation of the compression-ignition engine, a combustion event occurs during each engine cycle when fuel is pumped from a fuel tank 26 by a pump 28, under control of the engine control unit 24, and injected as a fuel charge into the combustion chamber to form, with the intake air, the cylinder charge. The cylinder charge is subsequently combusted by action of compression thereof during the compression stroke.

Sensing devices are installed on or near the engine to monitor physical characteristics and generate signals which are correlatable to engine and ambient parameters. The sensing devices include a crankshaft rotation sensor, comprising a crank sensor 30 for monitoring crankshaft speed through sensing edges on the teeth 32 of the multi-tooth target wheel 22. The crank sensor may comprise, e.g., a Hall-effect sensor, an inductive sensor, or a magnetoresistive sensor. Signal output from the crank sensor 30 is input to the engine control unit 24.

In an embodiment, the system may include other sensors for sensing various engine parameters including, but not limited to, a combustion pressure sensor, comprising a pressure sensing device adapted to monitor in-cylinder pressure, a manifold pressure sensor for monitoring manifold pressure and ambient barometric pressure, a mass air flow sensor for monitoring intake mass air flow and intake air temperature, and a coolant sensor. The system may also include an exhaust gas sensor for monitoring states of one or more exhaust gas parameters, e.g., temperature, air/fuel ratio, and constituents. Other sensing devices and methods for control and diagnostics purposes may also be included in the system 10 without departing from the broader aspects of the invention. Each of the sensing devices is signally connected to the engine control unit 24 to provide signal information which is transformed by the control module to information representative of the respective monitored parameter. It is understood that this configuration is illustrative, not restrictive, including the various sensing devices being replaceable with functionally equivalent devices and algorithms and still fall within the scope of the invention.

The actuators are installed on the engine and controlled by the engine control unit 24 in response to operator inputs to achieve various performance goals. In an embodiment, the actuators may include an electronically-controlled throttle device which controls throttle opening to a commanded input, and a plurality of fuel injectors 34 for directly injecting fuel into each of the combustion chambers in response to a commanded input, all of which are controlled in response to the operator torque request. The fuel injector 34 is an element of a fuel injection system, which comprises a plurality of high-pressure fuel injector devices each adapted to directly inject a fuel charge, comprising a mass of fuel, into one of the combustion chambers in response to the command signal from the engine control module 24. Each of the fuel injectors 12 are supplied pressurized fuel from a fuel distribution system including the fuel tank 26 and pump 28. In an embodiment, the injector command signal may encompass a command for pilot injection, main injection, and any subsequent post injection, depending upon the specific operating system used.

The engine 12 may further be equipped with a controllable valvetrain operative to adjust openings and closings of intake and exhaust valves of each of the cylinders, including any one or more of valve timing, phasing (i.e., timing relative to crank angle and piston position), and magnitude of lift of valve openings.

The engine control unit 24 functions according to instructions and algorithms stored in memory to control the aforementioned actuators to control engine operation, including, for example, fuel injection mass and timing. In particular, the engine control unit 24 is configured to receive input signals from the operator (e.g., a throttle position) to determine the operator torque request, and from the sensors indicating, for example, the engine speed. In an embodiment, the engine control unit 24 determines instantaneous control settings for fuel injection mass and timing from lookup tables and/or curves stored in memory. As indicated above, however, for any given throttle setting/position, the actual injected fuel mass may deviate from the desired fuel mass stored in a lookup table or curve due to any one of a number of factors. This deviation of actual injected fuel mass (or fuel quantity) from a base reference value (i.e., a desired or optimal injection fuel mass/quantity) is referred to as fuel mass offset.

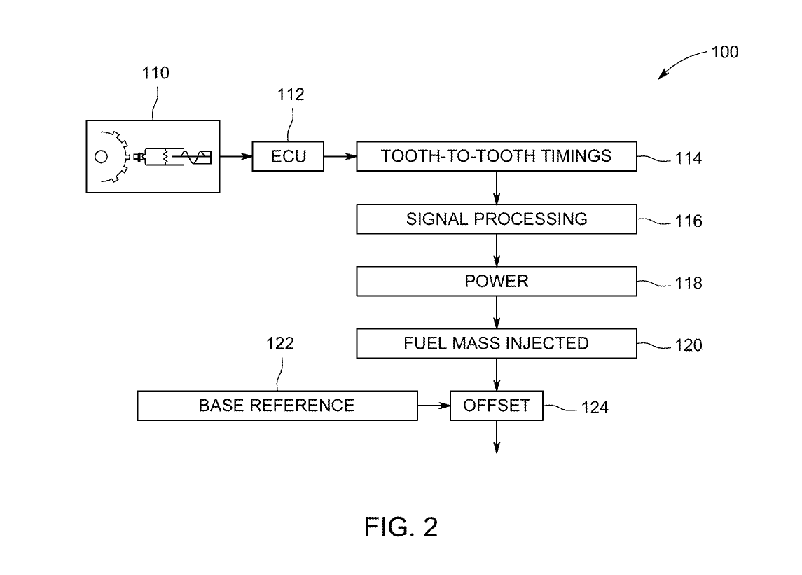

Referring now to FIG. 2, a method 100 for fuel injection control employed by the engine control unit 24 is illustrated. In an embodiment, the method 100 may be utilized to determine fuel mass offset for each fuel injector, and to control the injected fuel mass for each cylinder in dependence upon the determined fuel mass offset to increase engine performance, as a whole. In an embodiment, the engine control unit 24 is configured to analyze the frequency content of a crankshaft speed signal to identify torsional power levels of each cylinder of the engine during over-fueling at lower engine speeds. In an embodiment, the crankshaft speed signal, indicative of the crankshaft speed, is generated by a crankshaft speed sensor associated with the crankshaft of the engine. Individual cylinders are over-fueled and the crankshaft acceleration from each firing cylinder is leveraged to determine the power and, in turn, the fuel quantity of each injector via the half order (or harmonics) associated with the spectral analysis of the speed signal. The engine control system can then leverage this data to tune performance as necessary to calculate each over-fuel quantity level of each cylinder and account for the difference between the base reference and the injected fuel quantity.

Further to the above, if one cylinder starts to over-fuel (e.g., for a fuel mass correction strategy reason), the contribution onto the crankshaft will be unique and thus identifiable in a spectral analysis of the crankshaft speed sensor. In particular, as a result of combustion within each cylinder, the crankshaft 16 absorbs torque, producing a torsion (angular acceleration) effect on the crankshaft 16. These unique identifiable torsional power levels can be mapped to over-fuel injection quantity levels. For the first time of cylinder popping, the power levels can be calculated and stored, which will serve as a base reference for fuel offset calculation.

In connection with the above, in an embodiment, at step 110, the crankshaft speed sensor 30 monitors crankshaft speed through sensing edges on the teeth 32 of the multi-tooth target wheel 22. This crankshaft speed signal is communicated to the engine control unit 24, at step 112. Using this information, the engine control unit 24 determines the toot-to-tooth timings of the target wheel 22 for each cylinder firing, at step 114. These tooth-to-tooth timings of the target wheel 22 of the crankshaft are utilized to determine the crankshaft acceleration (i.e., torsion) attributable to each cylinder filing (i.e., each fuel injection event). The calculated torsion/acceleration due to each injection event can then be processed at step 116 using, e.g., a Goertzel algorithm, in order to determine the torsional power levels for each cylinder, at step 118.

With further reference to FIG. 2, at step 120, the determined torsional power levels of each cylinder are then converted or mapped to actual injected fuel quantities (i.e., an estimate of injected fuel mass of the quantity of injected fuel). In an embodiment, the mapping of torsional power levels to the injected fuel quantity/mass may be based on statistical or laboratory test results. More specifically, in an embodiment, the frequency content of the torsional oscillation (power level) is mapped to an actual injected fuel mass. The actual injected fuel mass may then be compared to a base reference value 122, in order to determine a fuel mass offset value for each injection, at step 124. These fuel mass offset values may then be utilized to update fuel injector maps to account for the deviations in actual injected fuel quantity from the base reference value. In an embodiment, over-power (i.e., torsional power levels greater than anticipated) indicates that more fuel was injected than desired, and the fuel injector maps may be updated to decrease the injected fuel mass for a given throttle setpoint. Conversely, under-power (i.e., torsional power levels lower than anticipated) indicates that less fuel was injected than desired, and the fuel injector maps may be updated to increase the injected fuel mass for the given throttle setpoint.

As used herein, and as referenced above, the “actual injected fuel mass” is a previously-determined value that corresponds to the torsional power level for the engine type in question, and is thereby an estimate of the mass (and not an exact mass) of the injected quantity of fuel.

In an embodiment, the base reference fuel mass values used in step 124 can be calculated during cylinder popping mode and stored in memory for use by the engine control unit 24. For example, during a pop test, each cylinder of the engine 12 is overfueled in a specific order for a specific duration. In an embodiment, as used herein, pop test or cylinder popping refers to a test where engine speed is maintained at approximately 330 rpm (or other designated RPM) with an engine output of approximately 30 GHP (or other designated power level). Each cylinder is overfueled for approximately 10 seconds (or other designated time period) followed by normal injection, with a 10 second (or other designated) gap between the overfueling of each respective cylinder (i.e., once cylinder is overfueled for 10 seconds, followed by normal injection; after 10 seconds, the process is repeated on another cylinder). For a 12 or 16 cylinder engine, each bank has 6 or 8 cylinders, respectively, and during bank shift, normal operation is maintained for approximately 30 seconds. During this time, an audible popping sound may be detected within the cylinders. As a result of this test, the half-order power levels (which vary according to fuel quantity) can be determined.

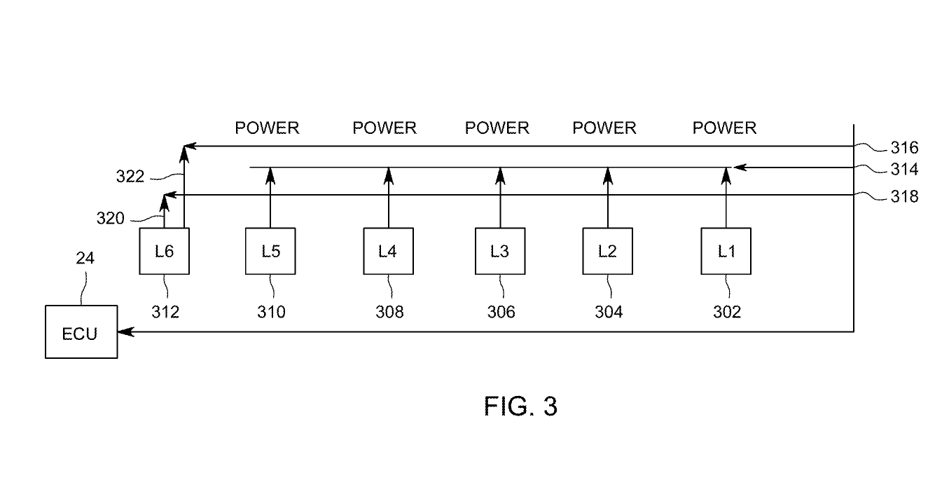

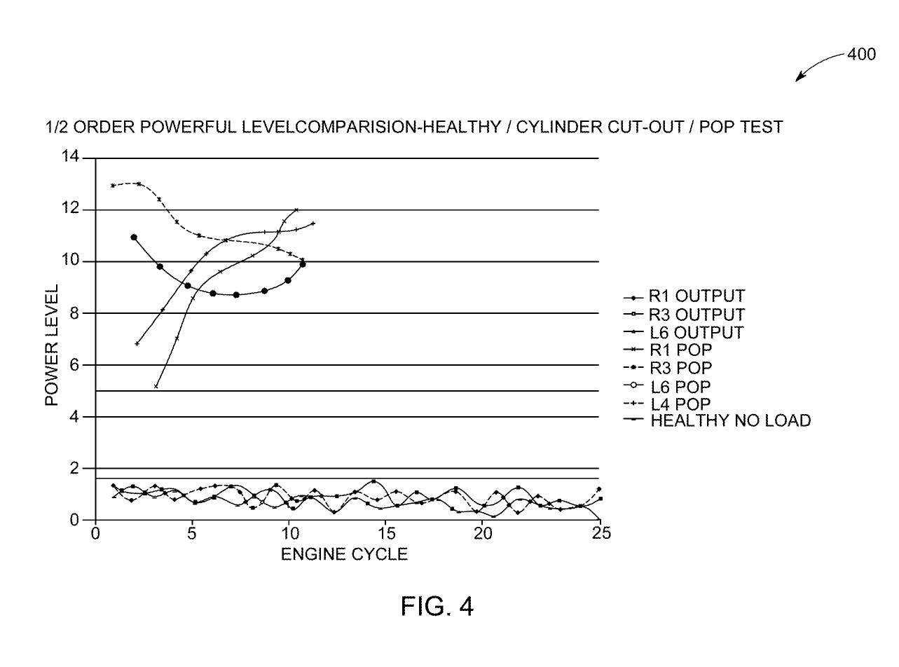

In connection with the above, a normal injector being over fueled will have a relatively high ½ order power level which in turn can be mapped to a relative fuel quantity level. This is best illustrated in FIG. 3, which depicts an exemplary plurality of cylinders, 302, 304, 306, 308, 310, 312, and their respective torsional power levels in reference to a base reference fuel injection level 314, an over-fuel level 316, and an under-fuel level 318. A healthy injector power level will match the reference level (see, e.g., cylinders 302, 304, 306, 308, 310), but any injector that has an issue due to ageing or the like will produce less (cylinder 312, power level 320) or more power levels (cylinder 312, power level 322) which, in turn, can be mapped to fuel quantity levels, as discussed above. These base reference fuel mass values, as indicated above, are therefore calculated and stored, and serve as reference values for fuel offset calculation going forward (e.g., at step 124), as indicated above. FIG. 4 is a diagram 400 illustrating a half-order power level comparison of a healthy fuel injector and a fuel injector exhibiting over-fueling. In an embodiment, the base reference values may be calculated during cylinder popping at low engine speed (e.g., 440 rpm or below).

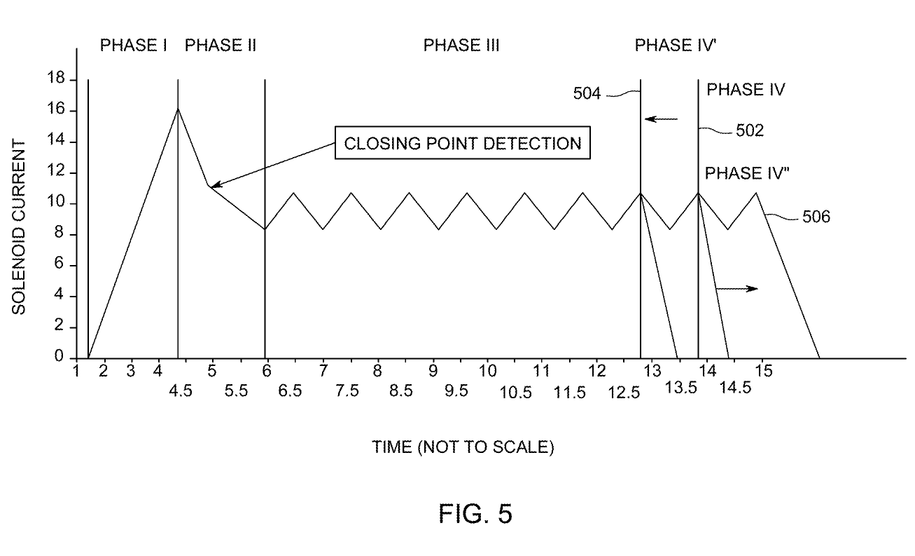

The invention described above provides a technical advantage in identifying the fuel injector offset correction values. The extra or less fuel injected can be calculated in the manner described above, and can be converted into injector excitation current adjustments as shown in FIG. 5, which is useful for precise control of fuel injection. In particular, as shown therein, depending on whether over-fueling or under-fueling is determined, the time duration of the fuel injection event can be decreased (as represented by line 504), or increased (as represented by line 506) in relation to a base reference duration 502.

In connection with the method 100 described above, with the injected fuel quantity level mapped from power levels, a threshold can be set which can be utilized to detect the ageing of a respective fuel injector. This threshold can then be utilized to determine when the fuel injectors should be replaced. For example, if a determined fuel mass offset value exceeds a predetermined threshold value, a notification or alert may be generated indicating the fuel injector at issue should be replaced.

The system and method of the invention therefore allows the lifetime of the fuel injectors to be increased, and provides for fuel savings which, in turn may decrease emissions (e.g., particulate matter, carbon dioxide and/or nitrogen oxide emissions). During cylinder healthy operation, fuel mass correction can also be identified during normal operation continuously. Learned offset values are stored in non-volatile memory for the next cycles of operation.

As indicated above, the system and method of the invention focuses on fuel injector offset adaption, which is a self-learning algorithm. As such, the method will adapt the fuel quantity in spite of injector ageing issues or mechanical issues, or blind replacement after a predetermined period of time. For example, in locomotive applications, fuel injectors are typically replaced every 18 to 20 months. The method of the invention, however, can increase the life span of the fuel injections by many times.

As indicated above, the system and method of the invention are configured to determine the injected fuel mass rather exactly and, in particular, to determine the deviations of the actual fuel injection amount that actually occurs during the operation of the combustion engine from the desired injection amount, in order to be able to carry out corresponding corrections and thus to be able to ensure a correct injection amount.

In an embodiment, a method for controlling an engine is provided. The method includes the steps of, with a fuel injector, injecting a quantity of fuel into a cylinder of the engine for combustion, calculating a torsional power level for the cylinder in response to the combustion of the injected quantity of fuel, mapping the torsional power level to an actual injected fuel mass, and comparing the actual injected fuel mass to a reference fuel mass to determine a fuel mass offset value. In an embodiment, the torsional power level is calculated using a crankshaft speed signal from a crankshaft speed sensor. In an embodiment, the method may also include the steps of monitoring a rotational speed of a crankshaft of the engine, and transmitting a crankshaft speed signal representing the rotational speed of the crankshaft to an engine control unit, wherein the engine control unit is configured to calculate the torsional power level based on a frequency content of the crankshaft speed signal. In an embodiment, the method may include the step of calculating the acceleration of the crankshaft of the engine resulting from the combustion of the injected quantity of fuel in the cylinder using the crankshaft speed signal, wherein the engine control unit is configured to determine the frequency content based on the acceleration. In an embodiment, the method may also include the step of updating a fuel injector map stored in memory of the engine control unit in dependence upon the determined fuel mass offset, wherein the engine control unit is configured to use the fuel injector map to control the fuel injector. In an embodiment, the method may include performing an injection correction based on the determined fuel mass offset, wherein the injection correction includes regulating an energizing time of the fuel injector. In an embodiment, the torsional power level is calculated during a cylinder popping mode. In an embodiment, the engine is a compression-ignition engine. In an embodiment, the engine is a spark-ignition engine. In an embodiment, the method may include comparing the fuel mass offset value to a threshold value stored in memory and, if the fuel mass offset value exceeds the threshold value, at least one of generating a notification or controlling the engine based on the fuel mass offset value.

In another embodiment, an engine system is provided. The engine system includes a cylinder defining a combustion chamber of an engine, a piston received in the cylinder and configured for reciprocating movement within the cylinder, a fuel injector in communication with the combustion chamber and being configured to inject a quantity of fuel into the cylinder, and an engine control unit in communication with the fuel injector, the engine control unit being configured to control the quantity of fuel injected into the cylinder. The engine control unit is further configured to calculate a torsional power level for the cylinder in response to combustion of the quantity of fuel injected into the cylinder, to determine an actual injected fuel mass corresponding to the torsional power level, and to determine a fuel mass offset by comparing the actual injected fuel mass to a reference fuel mass. In an embodiment, the system further includes a crankshaft attached to the piston, and a crankshaft speed sensor associated with the crankshaft, the crankshaft speed sensor being configured to detect a rotational speed of the crankshaft, wherein the engine control unit is configured to calculate the torsional power level based on the rotational speed of the crankshaft detected by the crankshaft speed sensor. In an embodiment, the engine control unit is configured to calculate the torsional power level of the cylinder in dependence upon an acceleration of the crankshaft resulting from the combustion of the quantity of fuel injected into the cylinder. In an embodiment, the engine control unit is configured to update a fuel injector map stored in memory of the engine control unit in dependence upon the determined fuel mass offset, the engine control unit configured to use the fuel injector map to control the fuel injector. In an embodiment, the engine control unit is configured to perform an injection correction based on the determined fuel mass offset, wherein the injection correction includes regulating an energizing time of the fuel injector. In an embodiment, the engine is a compression-ignition engine. In an embodiment, the engine is a spark-ignition engine. In an embodiment, the system may include a crankshaft attached to the piston, and a crankshaft speed sensor associated with the crankshaft, the crankshaft speed sensor being configured to output a crankshaft speed signal representing a rotational speed of the crankshaft. The engine control unit is configured to calculate the torsional power level based on a frequency content of the crankshaft speed signal, and the engine control unit is configured to control the engine based on the determined fuel mass offset.

In yet another embodiment, a method for controlling an engine includes, with a fuel injector, injecting a quantity of fuel into a cylinder of the engine for combustion. The method further includes calculating a torsional power level for the cylinder in response to the combustion of the injected quantity of fuel, and mapping the torsional power level to a mass (e.g., estimated mass) of the injected quantity of fuel (or otherwise determining an injected fuel mass corresponding to the torsional power level). The method further includes comparing the estimated mass to a reference fuel mass to determine a fuel mass offset value. In embodiments, the method further includes controlling the engine based on the fuel mass offset value (e.g., performing an injection correction of the fuel injector, such as changing an injection timing; and/or updating a fuel injector map used to control the fuel injector).

While embodiments of the invention are suitable for use with both compression-ignition and spark-ignition implementations, for ease of explanation a compression-ignition implementation is described in detail herein. More specifically, a diesel compression-ignition engine has been selected for clarity of illustration. In an embodiments, the engine may be embodied in both vehicles and machinery such as, for example, locomotives, off-highway vehicles and the like. Other suitable vehicles and machinery include, for example, on-road vehicles, construction equipment, industrial equipment, and marine vessels. As used herein, “electrical communication” or “electrically coupled” means that certain components are configured to communicate with one another through direct or indirect signaling by way of direct or indirect electrical connections. As used herein, “mechanically coupled” refers to any coupling method capable of supporting the necessary forces for transmitting torque between components. As used herein, “operatively coupled” refers to a connection, which may be direct or indirect. The connection is not necessarily being a mechanical attachment.

As used herein, an element or step recited in the singular and proceeded with the word “a” or “an” should be understood as not excluding plural of said elements or steps, unless such exclusion is explicitly stated. Furthermore, references to “one embodiment” of the present invention are not intended to be interpreted as excluding the existence of additional embodiments that also incorporate the recited features. Moreover, unless explicitly stated to the contrary, embodiments “comprising,” “including,” or “having” an element or a plurality of elements having a particular property may include additional such elements not having that property.

This written description uses examples to disclose several embodiments of the invention, including the best mode, and also to enable one of ordinary skill in the art to practice the embodiments of invention, including making and using any devices or systems and performing any incorporated methods. The patentable scope of the invention is defined by the claims, and may include other examples that occur to one of ordinary skill in the art. Such other examples are intended to be within the scope of the claims if they have structural elements that do not differ from the literal language of the claims, or if they include equivalent structural elements with insubstantial differences from the literal languages of the claims.

What is claimed is:

1. A method for controlling an engine, comprising:
with a fuel injector, injecting a quantity of fuel into a cylinder of the engine for combustion;
calculating a torsional power level for the cylinder in response to the combustion of the injected quantity of fuel;
mapping the torsional power level to an actual injected fuel mass; and
comparing the actual injected fuel mass to a reference fuel mass to determine a fuel mass offset value.

2. The method according to claim 1, wherein the torsional power level is calculated using a crankshaft speed signal from a crankshaft speed sensor.

3. The method according to claim 1, further comprising:
monitoring a rotational speed of a crankshaft of the engine; and
transmitting a crankshaft speed signal representing the rotational speed of the crankshaft to an engine control unit, wherein the engine control unit is configured to calculate the torsional power level based on a frequency content of the crankshaft speed signal.

4. The method according to claim 3, further comprising:
calculating the acceleration of the crankshaft of the engine resulting from the combustion of the injected quantity of fuel in the cylinder using the crankshaft speed signal, wherein the engine control unit is configured to determine the frequency content based on the acceleration.

5. The method according to claim 4, further comprising:
updating a fuel injector map stored in memory of the engine control unit in dependence upon the determined fuel mass offset, wherein the engine control unit is configured to use the fuel injector map to control the fuel injector.

6. The method according to claim 4, further comprising:
performing an injection correction based on the determined fuel mass offset, wherein the injection correction includes regulating an energizing time of the fuel injector.

7. The method according to claim 1, wherein the torsional power level is calculated during a cylinder popping mode.

8. The method according to claim 1, wherein the engine is a compression-ignition engine.

9. The method according to claim 1, wherein the engine is a spark-ignition engine.

10. The method according to claim 1, further comprising:
comparing the fuel mass offset value to a threshold value stored in memory; and
if the fuel mass offset value exceeds the threshold value, at least one of generating a notification or controlling the engine based on the fuel mass offset value.

11. An engine system comprising:
a cylinder defining a combustion chamber of an engine;
a piston received in the cylinder and configured for reciprocating movement within the cylinder;
a fuel injector in communication with the combustion chamber and being configured to inject a quantity of fuel into the cylinder; and
an engine control unit in communication with the fuel injector, the engine control unit being configured to control the quantity of fuel injected into the cylinder;
wherein the engine control unit is further configured to calculate a torsional power level for the cylinder in response to combustion of the quantity of fuel injected into the cylinder, to determine an actual injected fuel mass corresponding to the torsional power level, and to determine a fuel mass offset by comparing the actual injected fuel mass to a reference fuel mass.

12. The system of claim 11, further comprising:
a crankshaft attached to the piston; and
a crankshaft speed sensor associated with the crankshaft, the crankshaft speed sensor being configured to detect a rotational speed of the crankshaft, wherein the engine control unit is configured to calculate the torsional power level based on the rotational speed of the crankshaft detected by the crankshaft speed sensor.

13. The system of claim 12, wherein:
the engine control unit is configured to calculate the torsional power level of the cylinder in dependence upon an acceleration of the crankshaft resulting from the combustion of the quantity of fuel injected into the cylinder.

14. The system of claim 13, wherein:
the engine control unit is configured to update a fuel injector map stored in memory of the engine control unit in dependence upon the determined fuel mass offset, the engine control unit configured to use the fuel injector map to control the fuel injector.

15. The system of claim 13, wherein:
the engine control unit is configured to perform an injection correction based on the determined fuel mass offset, wherein the injection correction includes regulating an energizing time of the fuel injector.

16. The system of claim 11, wherein the engine is a compression-ignition engine.

17. The system of claim 11, wherein the engine is a spark-ignition engine.

18. The system of claim 11, further comprising:
a crankshaft attached to the piston; and
a crankshaft speed sensor associated with the crankshaft, the crankshaft speed sensor being configured to output a crankshaft speed signal representing a rotational speed of the crankshaft;
wherein the engine control unit is configured to calculate the torsional power level based on a frequency content of the crankshaft speed signal; and
wherein the engine control unit is configured to control the engine based on the determined fuel mass offset.

19. A method for controlling an engine, comprising:
with a fuel injector, injecting a quantity of fuel into a cylinder of an engine for combustion;
calculating a torsional power level for the cylinder resulting from the combustion of the fuel injected into the cylinder;
determining an injected fuel mass corresponding to the calculated power level;
determining a fuel mass offset by comparing the injected fuel mass to a reference fuel mass; and
controlling the engine based on the fuel mass offset that is determined.

20. The method according to claim 19, further comprising:
determining a rotational speed of a crankshaft of the engine;
wherein the power level is calculated using the rotational speed of the crankshaft.

21. The method according to claim 20, wherein the power level is calculated based on a frequency content of the rotational speed of the crankshaft.

22. The method according to claim 21, further comprising:
performing an injection correction based on the fuel mass offset that is determined, wherein the injection correction includes regulating an energizing time of the fuel injector.
